(19) United States
(12) Patent Application Publication
(10) Pub. No.: US 2014/0268456 A1
(43) Pub. Date: Sep. 18, 2014

(54) Relay Device

(71) Applicant: Yazaki Corporation, Tokyo (JP)

(72) Inventors: Shinobu Mochizuki, Makinohara-shi (JP); Takuma Takeno, Makinohara-shi (JP)

(73) Assignee: Yazaki Corporation, Tokyo (JP)

(21) Appl. No.: 14/291,507

(22) Filed: May 30, 2014

Related U.S. Application Data
(63) Continuation of application No. PCT/JP2012/081724, filed on Nov. 30, 2012.

(30) Foreign Application Priority Data
Dec. 1, 2011 (JP) 2011-263223

(51) Int. Cl. H02H 9/04

(52) U.S. Cl. CPC H02H 9/04
USPC 361/84; 361/91.5

(57) ABSTRACT

A relay device includes a relay circuit to which driving current is supplied from a battery, a driving circuit configured to drive the relay circuit, and a protecting circuit having a Schottky diode and a voltage suppressing element. The battery, the relay circuit, the driving circuit, and the protecting circuit are connected in series. The Schottky diode and the voltage suppressing element form a parallel body in which the Schottky diode and the voltage suppressing element are connected in parallel with each other with their forward directions set to the same directions.

### CROSS REFERENCE TO RELATED APPLICATIONS

This application is a continuation of PCT application No. PCT/JP2012/081724, which was filed on Nov. 30, 2012 based on Japanese Patent Application (No. 2011-263223) filed on Dec. 1, 2011, the contents of which are incorporated herein by reference.

### BACKGROUND OF THE INVENTION

1. Field of the Invention

The present invention relates to a relay device and more particularly to a relay device having a relay operation preventing function under, for instance, a reverse connection of a battery.

2. Description of the Related Art

In recent vehicles, various kinds of electronic controllers are mounted and a battery is mounted as a driving power source thereof. Since the battery mounted on the vehicle is a dc type, a sufficient attention needs to be paid so as to properly connect a connection polarity (positive/negative). In order to meet a proper connection or a surge due to an influence of a motor, a battery reverse connection preventing circuit is ordinarily provided.

FIG. 1 and FIG. 2 show relay devices 1 and 2 provided with battery reverse connection preventing circuits. The relay device 1 shown in FIG. 1 includes a relay circuit RLY provided between a source voltage Vbatt and a ground GND and a relay driving circuit 10 arranged in an upstream side (the source voltage Vbatt side) of the relay circuit RLY. The relay driving circuit 10 includes, for instance, a switching element such as a transistor. In a path of the relay driving circuit 10 and the source voltage Vbatt, that is, in a path of a driving current, a reverse current preventing diode D11 is arranged. The relay device 2 shown in FIG. 2 has a structure in which a relay driving circuit 20 is arranged in a downstream side (a ground GND side) of a relay circuit RLY. In a path of a source voltage Vbatt and the relay circuit RLY, a reverse current preventing diode D21 is arranged.

Not only the above-described circuits, but also various kinds of techniques are proposed as protecting circuits to be mounted on the vehicle. For instance, a technique is disclosed for meeting a surge voltage of a power source of a load and preventing over-current during the reverse connection of a battery (for instanced, see PTL 1). The protecting circuit disclosed in the PTL 1 includes a diode which is connected in parallel with an inductance type load and has a forward direction set to an opposite direction to a conducting direction of a source current and a Zener diode which is interposed between one terminal of the diode and one terminal of the load corresponding to the terminal of the diode and has a forward direction corresponding to the conducting direction of the source current. Further, a technique is disclosed for reducing a consumption of electric power during an ordinary time and preventing the generation of large current during the reverse connection of a battery (for instance, see PTL 2). Also in the protecting circuit disclosed in the PTL 2, a series body of a diode and a Zener diode is arranged in parallel with a load.

### CITATION LIST

### Patent Literature

[PTL 1] Japanese Patent Publication No. JP-A-2003-47287

[PTL 2] Japanese Patent Publication No. JP-A-2010-11598

### SUMMARY OF THE INVENTION

In the vehicle, such a problem occasionally arises that the source voltage Vbatt is extremely lowered due to a start of an engine. Ordinarily, since forward voltages of the reverse current preventing diodes D11 and D21 are high, voltages applied to the relay circuits RLY are low. Thus, in such a case, there is a fear that a turning on operation of the relay circuits RLY may not be possibly maintained. When the relay circuits RLY have functions for supplying electric power to a load associated with the start of the engine, if the turning on operation of the relay circuits RLY cannot be held, a problem arises that the engine cannot be started. On the other hand, the reverse current preventing circuits D11 and D21 may be supposed to be replaced by Schottky diodes whose forward voltages are low. However, since the Schottky diodes are weak in reverse voltage, there is a fear that the Schottky diodes may be possibly broken under a minus surge (for instance, −100V) generated in the source voltage Vbatt. Thus, a different technique is requested. Further, in the techniques disclosed in the PTL 1 and 2, the above-described problems cannot be solved, so that a different technique is still requested.

It is an object of the present invention to provide a technique which is devised by considering the above-described circumstances to solve the above-described problems.

According to one aspect of the present invention, there is provided a relay device including:
a relay circuit to which driving current is supplied from a battery;
a driving circuit configured to drive the relay circuit; and
a protecting circuit having a Schottky diode and a voltage suppressing element, wherein
the battery, the relay circuit, the driving circuit, and the protecting circuit are connected in series, and
the Schottky diode and the voltage suppressing element form a parallel body in which the Schottky diode and the voltage suppressing element are connected in parallel with each other with their forward directions set to the same directions.

A reverse voltage property of the Schottky diode may be higher than a level of reverse voltage as a voltage when the battery is reversely connected, and a suppressing voltage of the voltage suppressing element may be higher than the level of the reverse voltage and lower than the reverse voltage property of the Schottky diode. The voltage suppressing element may be a Zener diode.

According to the present invention, a technique can be provided which realizes a prevention of a relay operation under a reverse connection of a battery. Further, a technique can be provided which can suppress a voltage drop of a driving current path of a relay circuit.

### BRIEF DESCRIPTION OF THE DRAWINGS

FIG. 1 is a diagram showing a circuit structure of a relay device according to a usual technique.

FIG. 2 is diagram showing a relay device according to a usual technique.

FIG. 3 is a diagram showing a circuit structure of a relay device according to a first exemplary embodiment.

FIG. 4 is diagram showing a relay device according to a second exemplary embodiment.

### DETAILED DESCRIPTION OF THE EXEMPLARY EMBODIMENTS

Now, a mode for carrying out the invention (refer it to as an “exemplary embodiment”, hereinafter) will be described below by referring to the drawings. In the present exemplary embodiment, a structure is used in which a parallel body having a Schottky diode and a voltage suppressing element is arranged in place of a reverse current preventing diode.

Initially, specifications (1) to (4) required to be achieved as a relay device mounted on a vehicle will be described below.
(1) When a protecting circuit is added, a voltage drop of a driving current path of a relay circuit is suppressed as much as possible.
(2) The relay circuit is not operated under a reverse connection of a battery (−14V).
(3) Parts are not broken under a minus surge (−100V) generated in source voltage.
(4) Parts are not broken by a coil surge generated in a coil of the relay circuit during an operation that the relay circuit shifts from a turning on operation to a turning off operation.

In order to satisfy the above-described specification (1), the Schottky diode whose forward voltage is low is arranged as the reverse current preventing diode. Further, in order to satisfy the specification (2), a reverse voltage property of the Schottky diode is set to 14V or higher. Further, since the Schottky diode is too low in its reverse voltage performance to satisfy the above-described specification (3), the voltage suppressing element is connected in parallel with the Schottky diode and in the same direction as that of the Schottky diode as parts for protecting the Schottky diode. Further, suppressing voltage of the voltage suppressing element is set to be higher than the reverse voltage (14V) of the reverse connection of the battery and lower than the reverse voltage performance of the Schottky diode. The values of the reverse voltage property (14V) of the Schottky diode, the reverse voltage (14V) of the reverse connection of the battery and the minus surge (−100V) are merely shown as examples. It is to be understood to a person with ordinary skill in the art that they have different values depending on the specification of the vehicle.

As the voltage suppressing element, for instance, a Zener diode, a varistor and a surge absorber may be exemplified. When a transistor is provided in a relay driving circuit, the Zener diode which also serves to protect the transistor is preferably suitable. Now, specific circuit structures will be described in first and second exemplary embodiments.

### First Exemplary Embodiment

FIG. 3 is a diagram showing a circuit structure of a relay device 100 according to a first exemplary embodiment. In the relay device 100, the reverse current preventing diode D11 of the relay device 1 shown in FIG. 1 is replaced by a reverse current preventing circuit 150 and a driving circuit is further specifically shown.

As shown in the drawing, in the relay device 100, from a source voltage Vbatt to a ground GND, the reverse current preventing circuit 150, a relay driving circuit 110 and a relay circuit RLY are arranged in series. When a battery is properly connected, the source voltage Vbatt is set to +14V. When the battery is reversely connected by mistake, the source voltage Vbatt is set to −14V.

The reverse current preventing circuit 150 includes a Schottky diode D101 and a Zener diode ZD101. The Schottky diode D101 is connected in parallel with the Zener diode ZD101 and a forward direction of the Schottky diode D101 is the same as that of the Zener diode ZD101. Here, the forward direction indicates a direction directed toward the ground GND from the source voltage Vbatt. Namely, an upstream side (an anode side) of a parallel body including the Schottky diode D101 and the Zener diode ZD101 is connected to the source voltage Vbatt and a downstream side (a cathode side) is connected to the relay driving circuit 110.

The relay driving circuit 110 is driven by a driving control signal outputted from an output terminal (CPU_Output) of a prescribed controller. As a specific structure, the relay driving circuit 110 includes a PNP type first transistor Q101, an NPN type second transistor Q102, a Zener diode ZD102 and first to fourth resistances R101 to R104.

An emitter of the first transistor Q101 is connected to the reverse current preventing circuit 150. A collector is connected to the relay circuit RLY. Further, between the emitter and the collector of the first transistor Q101, the Zener diode ZD102 is connected. Here, an anode of the Zener diode D102 is connected to the collector. Further, between the emitter and the base of the first transistor Q101, the first resistance R101 is connected.

Further, to the base of the first transistor Q101, a collector of the second transistor Q102 is connected through the second resistance R102. An emitter of the second transistor Q102 is connected to the ground GND. A base is connected to the output terminal (CPU_Output) of the controller through the third resistance R103. Further, between the base and the emitter, the fourth resistance R104 is connected.

According to the first exemplary embodiment, the Schottky diode D101 and the Zener diode ZD101 of the reverse current preventing circuit 150 are set so as to satisfy the above-described specifications (1) to (4). As a result, when the battery is reversely connected, that is, when the source voltage Vbatt is, for instance, −14V, an operation can be properly prevented. Further, even when the minus surge is superimposed on the source voltage Vbatt, parts of the relay driving circuit 110 can be prevented from being destructed. Further, a voltage drop in a driving current path of the relay circuit from the source voltage Vbatt to the ground GND can be suppressed to a minimum.

### Second Exemplary Embodiment

FIG. 4 is a diagram showing a circuit structure of a relay device 200 according to a second exemplary embodiment. In the present exemplary embodiment, the reverse current preventing diode D21 of the relay device 2 shown in FIG. 2 is replaced by a reverse current preventing circuit 250 and a driving circuit is further specifically shown.

As shown in the drawing, in the relay device 200, from a source voltage Vbatt to a ground GND, the reverse current preventing circuit 250, a relay circuit RLY and a relay driving circuit 220 are arranged in series.

The reverse current preventing circuit 250 has the same structure as that of the reverse current preventing circuit 150 of the first exemplary embodiment which is a parallel body having a Schottky diode D201 connected in parallel with a Zener diode ZD201.

The relay driving circuit 220 is driven by a driving control signal outputted from an output terminal (CPU_Output) of a prescribed controller. As a specific structure, the relay driving circuit 220 includes an NPN type first transistor Q201, a Zener diode ZD202 and first and second resistances R201 and R202.

A collector of the first transistor Q201 is connected to a downstream side of the relay circuit RLY and an emitter is connected to the ground GND. Further, between the collector and the emitter (the ground GND), the Zener diode ZD202 is connected. Here, an anode is connected to the ground GND. To a base of the first transistor Q201, the output terminal (CPU_Output) of the controller is connected through the first resistance R201. Further, between the base and the emitter of the first transistor Q201, the second resistance R202 is connected.

As described above, according to the second exemplary embodiment, the same effects as those of the first exemplary embodiment can be obtained.

As mentioned above, the present invention is described in accordance with the exemplary embodiments. The exemplary embodiments are merely exemplified, and it is to be understood to a person with ordinary skill in the art that various modified examples may be made by components of them and combinations thereof and the modified examples are included within the scope of the present invention. For instance, the reverse current preventing circuits 150 and 250 have structures that the upstream sides are connected to the source voltage Vbatt; however, the present invention is not limited thereto. The arrangements may be suitably changed in their driving current paths. Specifically, between the relay circuit RLY and the ground GND or between the relay circuits RLY and the relay driving circuits 110 and 220, the reverse current preventing circuits 150 and 250 may be arranged.

It is apparent that various modifications can be made in the invention within a scope not deviating from the gist of the invention.

The present invention is useful for providing a relay device, which realizes a prevention of a relay operation under a reverse connection of a battery and suppresses a voltage drop of a driving current path of a relay circuit.

What is claimed is:

1. A relay device including:
a relay circuit to which driving current is supplied from a battery;
a driving circuit configured to drive the relay circuit; and
a protecting circuit having a Schottky diode and a voltage suppressing element, wherein
the battery, the relay circuit, the driving circuit, and the protecting circuit are connected in series, and
the Schottky diode and the voltage suppressing element form a parallel body in which the Schottky diode and the voltage suppressing element are connected in parallel with each other with their forward directions set to the same directions.

2. The relay device according to claim 1, wherein
a reverse voltage property of the Schottky diode is higher than a level of reverse voltage as a voltage when the battery is reversely connected, and
a suppressing voltage of the voltage suppressing element is higher than the level of the reverse voltage and lower than the reverse voltage property of the Schottky diode.

3. The relay device according to claim 1, wherein the voltage suppressing element is a Zener diode.
